(19) United States
(12) Patent Application Publication
(10) Pub. No.: US 2026/0185786 A1
(43) Pub. Date: Jul. 2, 2026

(54) WATER INJECTION MODULE OF HEAT EXCHANGER

(71) Applicant: KYUNGDONG NAVIEN CO., LTD., Pyeongtaek-si (KR)

(72) Inventors: Chan Woo NAM, Seoul (KR); Myoung Seop LEE, Seoul (KR); Hyun Seok YANG, Seoul (KR)

(21) Appl. No.: 19/436,126

(22) Filed: Dec. 30, 2025

(30) Foreign Application Priority Data
Dec. 30, 2024 (KR) 10-2024-0201011

(51) Int. Cl. F28F 27/00; F28D 3/04

(52) U.S. Cl. CPC F28F 27/00; F28D 3/04

(57) ABSTRACT

A water injection module includes a spray pipe having a nozzle formed to spray water toward a heat exchange target object, a water supply line configured to supply water from a water supply source to the spray pipe, the water supply line including a water supply valve, an air pump provided on a first line branching from the water supply line adjacently to the water supply pipe, a drain valve provided on a second line branching from the water supply line, and a controller connected to the water supply valve, the drain valve, and the air pump, the controller including a processor and a memory connected to the processor, the memory in which a program performing an operation is stored, the controller configured to control operations of the water supply valve, the drain valve, and the air pump.

### CROSS-REFERENCE TO RELATED APPLICATION(S)

This application claims benefit of priority to Korean Patent Application No. 10-2024-0201011 filed on Dec. 30, 2024, the disclosure of which is incorporated herein by reference in its entirety.

### BACKGROUND

### 1. Field

The present disclosure relates to a water injection module of a heat exchanger, and more specifically, to a water injection module of a heat exchanger having a residual water removal function.

### 2. Description of Related Art

In general, a heat exchanger may be an apparatus for exchanging heat between two fluids for the purpose of heat recovery, and may include a cooler for cooling a high-temperature-side fluid, a heater for heating a low-temperature-side fluid, a condenser for condensing steam, and an evaporator for evaporating a low-temperature-side fluid.

In particular, an evaporative condenser in which a water-cooled type operation and an air-cooled type operation are mixed may be configured in a manner in which water is sprayed onto a tube through which a cooling fluid passes, air supplied from a blower is guided to flow toward a surface of the tube, and water vapor evaporated from the tube surface is discharged to cool the cooling fluid.

An evaporative cooler may be configured to alternately and repeatedly form a wet channel and a dry channel, and to supply cooled air into a room through the dry channel through heat exchange caused by evaporation in the wet channel. Specifically, latent heat of evaporation of water injected into first air passing through the wet channel may be configured to cool second air passing through the dry channel.

Here, it may be important that water injection nozzles included in the evaporative condenser and the evaporative cooler maintain a constant water injection angle and water injection flow rate for fine spraying. To this end, there arises a need to improve durability of a nozzle. However, when the water injection nozzles receive water from a water supply source and spray water, mineral components (such as Ca and Mg ions) in tap water may react with H₂CO₃ to form scale in the solid form of CaCO₃ and MgCO₃. The scale may cause changes in the water injection angle and water injection flow rate, or may clog the water injection nozzles.

### SUMMARY

An aspect of the present disclosure is to provide a water injection module capable of removing residual water remaining in a spray pipe when operation of the heat exchanger ends.

According to an aspect of the present disclosure, there is provided a water injection module including a spray pipe having a nozzle formed to spray water toward a heat exchange target object, a water supply line configured to supply water from a water supply source to the spray pipe, the water supply line including a water supply valve, an air pump provided on a first line branching from the water supply line adjacently to the water supply pipe, a drain valve provided on a second line branching from the water supply line, and a controller connected to the water supply valve, the drain valve, and the air pump, the controller including a processor and a memory connected to the processor, the memory in which a program performing an operation is stored, the controller configured to control operations of the water supply valve, the drain valve, and the air pump.

In an example embodiment, the controller may be set to identify whether a period of time during which the water supply valve is maintained in a closed state has exceeded a designated waiting period of time.

In an example embodiment, when it is identified that the designated waiting period of time has elapsed, the controller may be set to open the water supply valve during a designated first period of time, to open the drain valve during a designated second period of time, and to operate the air pump during a designated third period of time.

In an example embodiment, the controller may be set to start opening of the drain valve and operation of the air pump, after the water supply valve is opened during the first period of time and closed and a designated rest period of time elapses.

In an example embodiment, the second period of time may be shorter than the third period of time.

In an example embodiment, the waiting period of time may be designated to be equal to or greater than one hour and less than nine hours.

In another example embodiment, the water injection module may further include a total dissolved solid (TDS) meter provided on a third line branching from the water supply line. The controller may be set to receive water quality information from the TDS meter, and to designate the waiting period of time based on the water quality information.

In an example embodiment, the controller may be set to identify whether operation of the heat exchange target object has started. When it is identified that the operation has started, the controller may be set to open the water supply valve, to maintain opening of the water supply valve during a designated fourth period of time, to close the water supply valve during a designated fifth period of time, and to open the water supply valve again.

In an example embodiment, the controller may be set to identify whether operation of the heat exchange target object has ended. When it is identified that the operation has ended the controller may be set to close the water supply valve after a designated extension period of time elapses.

In an example embodiment, the controller may be set to open the water supply valve, when it is identified that the designated waiting period of time has elapsed, and then it is identified that operation of the heat exchange target object has started during control of the water supply valve, the drain valve, and the air pump.

According to another aspect of the present disclosure, there is provided a heat exchanger including a water injection module of one of claims 1 to 10.

The present disclosure may provide a water injection module capable of preventing clogging of a nozzle and maintaining a consistent water injection angle by removing residual water through pressurization.

In addition, according to the present disclosure, a heat exchanger may have cooling performance that is optimally maintained through a water injection module reducing scale formation caused by residual water and spraying water widely over an evaporation area.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic diagram of a water injection module of a heat exchanger according to an example embodiment of the present disclosure;

FIG. 2 is a block diagram of a controller controlling a water injection module according to an example embodiment of the present disclosure;

FIG. 3 is a flowchart of a method of controlling a water injection module of a heat exchanger according to example embodiments of the present disclosure;

FIG. 4 is a flow diagram of a method of controlling a water injection module of a heat exchanger according to example embodiments of the present disclosure;

FIG. 5 is a flowchart of a portion of a method of controlling a water injection module of a heat exchanger according to an example embodiment of the present disclosure;

FIG. 6 is a flowchart of another portion of a method of controlling a water injection module of a heat exchanger according to an example embodiment of the present disclosure;

FIG. 7 is a schematic diagram of a water injection module of a heat exchanger according to another example embodiment of the present disclosure; and

FIG. 8 is a graph illustrating designation of a waiting period of time for residual water removal in a water injection module according to another example embodiment of the present disclosure.

### DETAILED DESCRIPTION

Hereinafter, with reference to the attached drawings, a detailed description of specific embodiments of the present invention will be provided. However, the spirit of the present invention is not limited to the presented embodiments, and those skilled in the art, upon understanding the spirit thereof, may propose additional embodiments within the scope of the invention that may be considered less advanced or the present invention by adding, modifying, or deleting various components. Such embodiments are also considered to fall within the scope of the present invention.

As used herein, when a component is described as “connected to,” or “coupled to” another component, it may be directly “connected to,” or “coupled to” the other component, or there may be one or more other components intervening therebetween. In addition, it will be understood that “comprise” or “include” and/or “comprising” or “including” specify the presence of components, but do not preclude the presence or addition of other components.

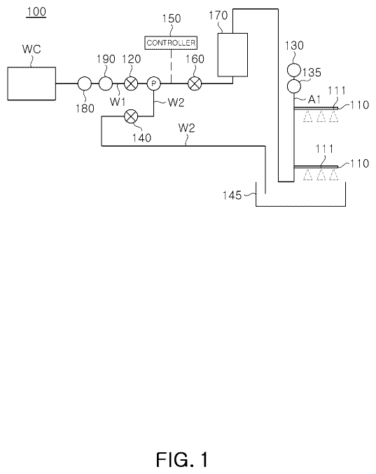

FIG. 1 is a schematic diagram of a water injection module of a heat exchanger according to an example embodiment of the present disclosure.

Referring to FIG. 1, a water injection module 100 of a heat exchanger 10 according to an example embodiment of the present disclosure may include a spray pipe 110 in which a nozzle 111 is formed to spray water toward a heat exchange target object, a water supply line W1 supplying water from a water supply source WS to the spray pipe 110, the water supply line W1 including a water supply valve 120, an air pump 130 provided on a first line A1 branching from the water supply line W1 adjacently to the spray pipe 110, a drain valve 140 provided on a second line W2 branching from the water supply line W1, and a controller 150 controlling operation of the water supply valve 120, the drain valve 140, and the air pump 130.

The spray pipe 110 may include a plurality of nozzles 111, and the spray pipe 110 may be arranged to spray water toward the heat exchange target object (not illustrated). The heat exchange target object may be a surface of a tube through which a cooling fluid of an evaporative condenser passes or a wet channel of an evaporative cooler. The plurality of nozzles 111 may finely spray water evenly onto an evaporation area toward the heat exchange target object at a constant water injection angle. As described above, scale is formed in the plurality of nozzles due to residual water, the water injection angles of the plurality of nozzles may become misaligned or, in severe cases, the nozzles may become clogged.

The water supply line W1 may provide a passage for water to move from the water supply source WS to the spray pipe 110. As illustrated, in order to smoothly supply water to the spray pipe, a strainer 180, a check valve 190, a water supply valve 120, a pressure gauge P, a pressure reducing valve 160, and a water purification filter 170 may be sequentially installed on the water supply line W1 from upstream to downstream.

The strainer 180, a component filtering foreign substances contained in water directly supplied from the water supply source WS, may include a mesh-type screen, which may be replaceable. The check valve 190 may allow water from the water supply source WS to flow toward the water supply valve 120, and may prevent backflow of water when components such as the water supply valve 120 and the like are stopped, thereby protecting the water supply valve 120.

The water supply valve 120, a control valve installed on the water supply line W1 and regulated by control commands of the controller 150, may control water flow supplied to the spray pipe 110. The controller 150 may control opening and closing of the water supply valve 120 and a degree of opening of the water supply valve 120.

The pressure reducing valve 160 may adjust a pressure of water passing through the water supply line W1 to a preset reference pressure, and the pressure gauge P may measure the pressure of water passing through the water supply line W1. The reference pressure may refer to a pressure at which water supplied through the water supply line W1 to the nozzle 111 may be properly sprayed, that is, a pressure suitable for fine spraying. The reference pressure may prevent damage to the nozzle 111, maintain a constant water injection angle and water injection flow rate for fine spraying, and enhance durability of the nozzle 111.

The water purification filter 170 may filter mineral components contained in water to reduce scale formation on the nozzle 111. Scale caused by evaporation may refer to a phenomenon in which a mineral component is deposited on a surface of a facility. When scale occurs in an evaporative heat exchanger heat transfer efficiency may be reduced, and in severe cases, a flow path may be blocked.

In example embodiments of the present disclosure, the heat exchanger ay further include an air pump 130 and a drain valve 140 to remove residual water after water injection. The air pump 130 may be provided on an end of the first line A1 branching from the water supply line W1 adjacently to the spray pipe 110, in particular upstream of the spray pipe 110. A check valve 135 may be further provided on the first line A1. The check valve 135 may serve to prevent backflow of water from the water supply line W1 into the air pump 130 of the first line A1, and to protect the air pump 130. The drain valve 140 may be provided on the second line W2 branching from the water supply line W1 adjacently to a downstream of the water supply valve 120. An end of the second line W2 may be connected to a drain plate 145 collecting residual water moving in the water supply line W1.

The air pump 130 and the drain valve 140 may be operated when the water supply valve 120 is closed. The air pump 130 may be operated to pressurize air pressure at a branch point of the water supply line W1 through the first line A1. By operation of the air pump 130, residual water present in the water supply line W1 downstream of the water supply valve 120 and in the spray pipe 110 may be pushed by air pressure to flow toward the second line W2 in which the drain valve 140 is opened, or may be sprayed from the nozzle 111. As a result, residual water present in the water supply line W1 downstream of the water supply valve 120 and in the spray pipe 110 may be removed.

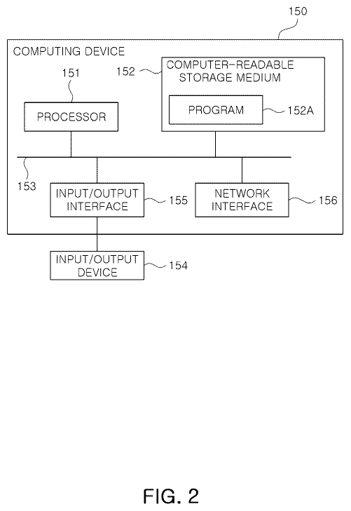

FIG. 2 is a block diagram of a controller 150 controlling a water injection module according to an example embodiment of the present disclosure.

As illustrated in FIG. 2, the controller 150 may be a computing device, and the controller 150 may include at least one processor 151, a computer-readable storage medium 152, and a communication bus 153. For example, the controller 150 may include a personal computer, a server computer, a handheld or laptop device, a mobile device (mobile phone, PDA, media player, or the like), a multiprocessor system, a consumer electronic device, a mini-computer, a mainframe computer, or a distributed computing environment including any of the above-described system or device, but the present disclosure is not limited thereto.

The processor 151 may cause the computing device to operate according to the exemplary embodiments described above. For example, the processor 151 may execute one or more programs stored in the computer-readable storage medium 152. The one or more programs may include one or more computer-executable instructions. When the computer-executable instructions are executed by the processor 151, the processor 151 may be configured to cause the computing device 150 to perform the operations according to the example embodiments. For example, the processor 151 may include a central processing unit (CPU), a graphics processing unit (GPU), a microprocessor, an application specific integrated circuit (ASIC), a field programmable gate array (FPGA), or the like, and may have a plurality of cores. The memory 1120 may be a volatile memory (for example, a RAM or the like), a non-volatile memory (for example, a ROM, a flash memory, or the like), or a combination thereof.

The computer-readable storage medium 152 may be configured to store the computer-executable instruction or program code, program data, and/or other suitable forms of information. A program 152a stored in the computer-readable storage medium 152 may include a set of instructions executable by the processor 151. In an example embodiment, the computer-readable storage medium 152 may be a memory (volatile memory such as a random access memory, non-volatile memory, or any suitable combination thereof), one or more magnetic disk storage devices, optical disk storage devices, flash memory devices, other types of storage media that are accessible by the computing device 150 and are capable of storing desired information, or any suitable combinations thereof.

The communication bus 153 may interconnect various other components of the computing device, including the processor 151 and the computer-readable storage medium 152.

The computing device 12 may also include one or more input/output interface 155 providing an interface for one or more input/output devices 154, and one or more network communication interfaces 156. The input/output interface 155 and the network communication interface 156 may be connected to the communication bus 153. The input/output device 24 may be connected to other components of the controller 150, which is the computing device, through the input/output interface 155. The exemplary input/output device 154 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The exemplary input/output device 154 may be included in the controller 150 as a component included in the computing device 12, or may be connected to the controller 150 as a device distinct from the computing device 400.

Example embodiments of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the example embodiments, or may be of the well-known kind and available to those having skill in the computer software arts. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code that may be executed by the computer using an interpreter.

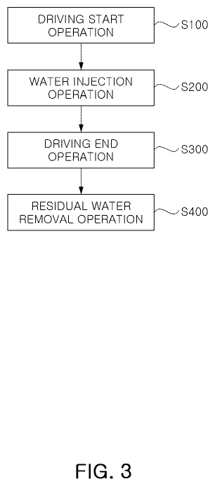

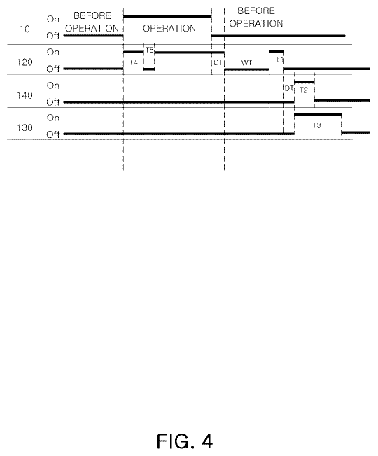

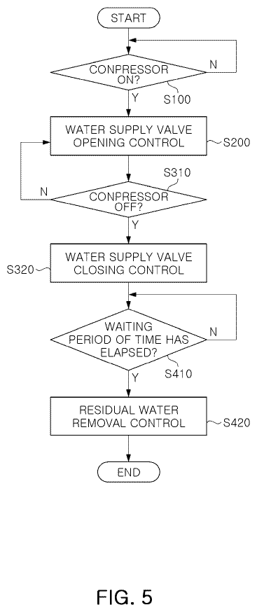

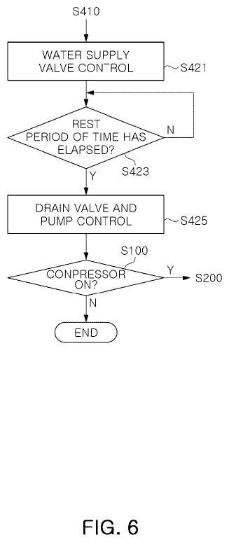

FIGS. 3 and 4 are a flowchart and a flow diagram of a method of controlling a water injection module of a heat exchanger according to example embodiments of the present disclosure. FIGS. 5 and 6 are flowcharts of a portion and another portion of a method of controlling a water injection module of a heat exchanger according to an example embodiment of the present disclosure.

Referring to FIGS. 3 to 6, a method of controlling a water injection module 100 of a heat exchanger 10 according to example embodiments of the present disclosure may be performed by control commands of the controller 150 for the above-described components of the water injection module 100, and may include a driving start operation S100, a water injection operation S200, a driving end operation S300, and a residual water removal operation S400.

In operation S100, a controller 150 may identify whether operation to a heat exchange target object has started. The illustrated example embodiment may be a case in which the heat exchange target object is a surface of a tube through which a cooling fluid of an evaporative condenser passes, and may be an example of identifying whether operation of the heat exchange target object has started through ON/OFF of a compressor introducing the cooling fluid into the tube. Operation S100 is not limited to the present example using operation information of the compressor, and other information may be used depending on a heat exchanger. The controller 150 may perform operation S200 of controlling opening and closing of a water supply valve 120 when it is identified that operation of the heat exchange target object has started, and may shift to a standby mode when it is identified that operation of the heat exchange target object has not started.

In operation S200, the controller 150 may open the water supply valve 120 such that water is supplied to a spray pipe 110. More specifically, the controller 150 may open the water supply valve 120 and maintain opening of the water supply valve 120 during a designated fourth period of time T4, and may control opening and closing of the water supply valve 120 such that the water supply valve 120 is opened again after the water supply valve 120 is closed during a designated fifth period of time T5. The fourth period of time T4, which is an opening period of time, and the fifth period of time T5, which is a closing period of time, may be pre-designated. In an example, the fourth period of time T4 and the fifth period of time T5 may be 1 minute and 5 seconds, respectively. In operation S200, when operation of the heat exchange target object is continuing, the controller 150 may maintain opening of the water supply valve 120.

Operation S300 may include operation S310 of identifying whether operation of a heat exchange target object has ended and operation S320 of controlling closing of a water supply valve. In operation S310, a controller 150 may identify whether operation of the heat exchange target object has ended. The illustrated example embodiment may be a case in which the heat exchange target object is a surface of a tube through which a cooling fluid of an evaporative condenser passes, and may be an example of identifying whether operation of the heat exchange target object has ended through OFF of a compressor introducing the cooling fluid into the tube. Operation S310 is not limited to the present example using operation information of the compressor, and other information may be used depending on a heat exchanger.

In operation S310, when it is identified that operation of the heat exchange target object has ended, the controller 150 may control a water supply valve 120 not to be immediately closed, but to be closed after a designated extension period of time ET in operation S320. This may be for continuing heat exchange with residual fluid remaining in the heat exchanger during the extension period of time ET. The extension period of time ET may be pre-designated. In an example, the extension period of time ET may be 30 seconds.

Operation S400 may include operation S410 of identifying whether a period of time during which a water supply valve 120 is maintained in a closed state has exceeded a designated waiting period of time WT, and a control operation S420 of removing residual water. In operation S410, a controller 150 may identify whether the period of time during which the water supply valve 120 is maintained in a closed state has exceeded the designated waiting period of time WT.

In operation S410, when the controller 150 identifies that the period of time during which the water supply valve 120 is maintained in a closed state has exceeded the designated waiting period of time WT, operation S420 may be performed. In operation S410, when the controller 150 identifies that the period of time during which the water supply valve 120 is maintained in a closed state has not exceeded the designated waiting period of time WT, the process may return to the operation before operation S410. The waiting period of time WT may be pre-designated by a user. In an example, the waiting period of time WT may be designated within a range of 1 hour or more and less than 9 hours, and the waiting period of time WT may be preferably 8 hours.

In an example embodiment, a reason why the waiting period of time WT is designated as 8 hours may be to prevent an increase in water usage caused by repetition of the residual water removal operation, and to take into account that biofilm particularly tends to develop well after water supply cutoff of 9 hours. A biofilm may be a thin film formed by microorganisms adhering to a surface thereof, and may also be referred to as a biological film. In addition, another reason why the waiting period of time WT is designated as 8 hours may be that frequent drainage may further accelerate scale formation. The present inventor has confirmed that scale formation during about 1000 hours occurred more than about 7 times greater when concentrated water having a TDS of about 650 ppm was continuously supplied while a blower was operated, as compared to when the blower was not operated. Accordingly, it was determined that delaying a residual water removal time to reduce the number of drying operations, rather than performing frequent residual water removal, that is, drainage, would be more effective in suppressing scale formation.

Operation S420 may include operation S421 of controlling the water supply valve 120, operation of identifying whether a rest period of time has elapsed, and operation S425 of controlling a drain valve and an air pump. In operation S410, when the controller 150 identifies that the period of time during which the water supply valve 120 is maintained in a closed state has exceeded the designated waiting period of time WT, the controller 150 may control the water supply valve 120 to be opened during a designated first period of time T1 in operation S421. The first period of time T1 may be pre-designated. In an example, the first period of time T1 may be 2 minutes. A reason for opening the water supply valve 120 in operation S421 may be to discharge microorganisms and biofilms within residual water that has been stagnant during the waiting period of time WT to the outside of a nozzle.

In operation S423, the controller 150 may identify whether a designated rest period of time DT has elapsed after the water supply valve 120 is opened during the first period of time T1 and closed. In operation S423, when the controller 150 identifies that the designated rest period of time DT has elapsed after the water supply valve 120 is opened during the first period of time T1 and closed, operation S425 may be performed. In operation S423, when the controller 150 identifies that the designated rest period of time DT has not elapsed after the water supply valve 120 is opened during the first period of time T1 and closed, the process may return to the operation before operation S423. The rest period of time DT may be pre-designated. In an example, the rest period of time DT may be 5 seconds. A reason for setting the rest period of time DT in operation S423 may be to take into account an ON/OFF switching time of the water supply valve 120 and a drain valve 140, and to partially drain residual water toward the drain valve 140 and a nozzle 111 so as to reduce an operating period of time of the air pump 130.

In operation S425, when the controller 150 identifies in operation S423 that the designated rest period of time DT has elapsed after the water supply valve 120 is opened during the first period of time T1 and closed, the controller 150 may open the drain valve 140 during a designated second period of time T2, and may control the air pump 130 to be operated during a designated third period of time T3.

In operation S425, the air pump 130 and the drain valve 140 may be operated in a state which the water supply valve 120 is closed. The air pump 130 may be operated to pressurize air pressure to a branch point of the water supply line W1 through a first line A1. Residual water present in the water supply line W1 downstream of the water supply valve 120 and in the spray pipe 110 may be pushed by air pressure to flow through a second line W1 in which the drain valve 140 is opened, or may be sprayed from the nozzle 111. As a result, residual water present in the water supply line W1 downstream of the water supply valve 120 and in the spray pipe 110 may be removed.

The second period of time T2, which is an operating period of time of the drain valve 140 in operation S425, and the third period of time T3, which is an operating period of time of the air pump 130, may be pre-designated. In an example, the second period of time T2 and the third period of time T3 may be 1 minute and 7 minutes, respectively. The second period of time T2, which is an opening period of time of the drain valve 140, is shorter than the third period of time T3, which is an operating period of time of the air pump 130. This may be for inducing residual water to be discharged to the nozzle 111 by first closing the drain valve 140.

When an operation start signal of the heat exchanger is received while operation S420 is performed, the controller 150 may perform operation S100. When it is identified that operation of a heat exchange target object has started, the process may return to operation S200. That is, when the controller 150 identifies that the waiting period of time WT has elapsed in operation S410, and then identifies that operation of the heat exchange target object has started during control of the water supply valve 120, the drain valve 140, and the air pump 130, the controller 150 may be set to open the water supply valve 120 and to perform the water injection operation S200.

The controller 150 may be set to close the water supply valve 120 when an outdoor temperature is less than 2 degrees. This may be for preventing the water injection modules 100 and 101 from being frozen.

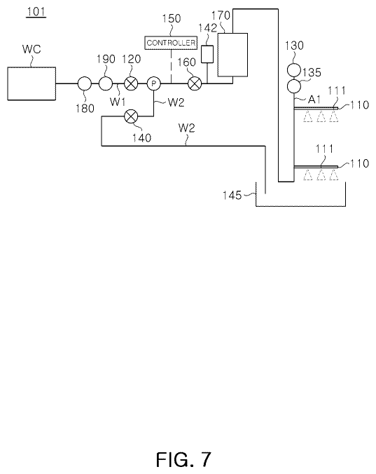

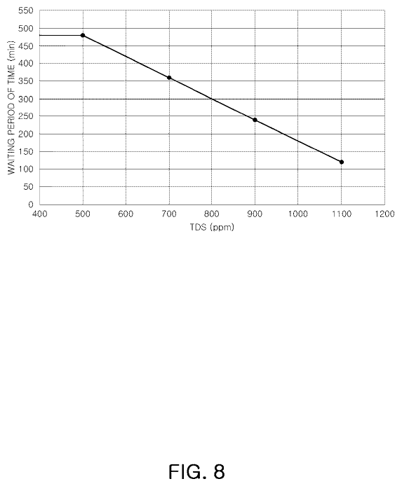

FIG. 7 is a schematic diagram of a water injection module of a heat exchanger according to another example embodiment of the present disclosure. FIG. 8 is a graph illustrating designation of a waiting period of time for residual water removal in a water injection module according to another example embodiment of the present disclosure.

Referring to FIGS. 7 and 8, a water injection module 101 of a heat exchanger according to another example embodiment of the present disclosure may further include a total dissolved solid (TDS) meter 142 provided on a third line branching from a water supply line W1, and a controller 150 may be set to receive water quality information from the TDS meter 142 and to designate a waiting period of time WT based on the water quality information. A biofilm may tend to be more readily generated as a TDS is higher, such that the waiting period of time WT may be set to be shorter as the TDS is higher, as illustrated.

While example embodiments have been shown and described above, it will be apparent to those skilled in the art that modifications and variations could be made without departing from the scope of the present disclosure as defined by the appended claims.

What is claimed is:

1. A water injection module comprising:
a spray pipe having a nozzle formed to spray water toward a heat exchange target object;
a water supply line configured to supply water from a water supply source to the spray pipe, the water supply line including a water supply valve;
an air pump provided on a first line branching from the water supply line adjacently to the water supply pipe;
a drain valve provided on a second line branching from the water supply line; and
a controller connected to the water supply valve, the drain valve, and the air pump, the controller including a processor and a memory connected to the processor, the memory in which a program performing an operation is stored, the controller configured to control operations of the water supply valve, the drain valve, and the air pump.

2. The water injection module of claim 1, wherein the operation includes identifying whether a period of time during which the water supply valve is maintained in a closed state has exceeded a designated waiting period of time.

3. The water injection module of claim 2, wherein, when it is identified that the designated waiting period of time has elapsed, the operation includes setting the water supply valve to be opened for a designated first period of time, the drain valve to be opened for a designated second period of time, and the air pump to be operated for a designated third period of time.

4. The water injection module of claim 3, wherein the operation includes setting the start of the drain valve opening and the air pump operation to occur after a designated rest period of time, the rest time occurring after the water supply valve has been opened and closed for the first period of time.

5. The water injection module of claim 3, wherein the second period of time is shorter than the third period of time.

6. The water injection module of claim 2, wherein the waiting period of time is designated to be equal to or greater than one hour and less than nine hours.

7. The water injection module of claim 2, further comprising:
a total dissolved solid (TDS) meter provided on a third line branching from the water supply line,
wherein the controller is connected to the TDS meter to receive water quality information from the TDS meter, and
the operation includes an operation of the controller set to designate the waiting period of time based on the water quality information.

8. The water injection module of claim 1, wherein the operation includes:
setting the controller to identify whether operation of the heat exchange target object has started, and
when the start of the operation is identified, to open the water supply valve, maintain the opening of the water supply valve for a designated fourth period of time, close the water supply valve for a designated fifth period of time, and then open the water supply valve again.

9. The water injection module of claim 1, wherein the operation includes:
setting the controller to identify whether operation of the heat exchange target object has ended, and,
when the end of the operation is identified, to close the water supply valve after a designated extension period of time.

10. The water injection module of claim 3, wherein the operation includes:
setting the controller to open the water supply valve when the start of the operation of the heat exchange target object is identified during the control of the water supply valve, the drain valve, and the air pump, after the designated waiting period of time has been exceeded.

11. A heat exchanger comprising:
a tube through which a cooling fluid passes; and
a heat exchanger including the water spray module of claim 1.
